(19) United States
(12) Patent Application Publication
(10) Pub. No.: US 2025/0001520 A1
(43) Pub. Date: Jan. 2, 2025

(54) LASER PROCESSING METHOD

(71) Applicant: DISCO CORPORATION, Tokyo (JP)

(72) Inventors: Asahi NOMOTO, Tokyo (JP); Kazuya HIRATA, Tokyo (JP)

(21) Appl. No.: 18/755,966

(22) Filed: Jun. 27, 2024

(30) Foreign Application Priority Data
Jun. 29, 2023 (JP) 2023-106994

(51) Int. Cl. B23K 26/066; B23K 26/0622; B23K 26/53

(52) U.S. Cl. CPC B23K 26/066; B23K 26/0622; B23K 26/53

(57) ABSTRACT

A laser processing method includes a laser beam applying step of applying, while masking, with a masking unit, part of a pulsed laser beam having a wavelength transmittable through a workpiece such that the part of the laser beam that enters the workpiece via an outer peripheral side surface thereof has an intensity smaller than a processing threshold value of the workpiece, adjusting the height of a focused spot of the laser beam to position the focused spot within the workpiece, and moving the focused spot and the workpiece relatively to each other so as to move the focused spot along an outer peripheral area of the workpiece, thereby forming a modified layer in the workpiece.

### BACKGROUND OF THE INVENTION

### Field of the Invention

The present invention relates to a laser processing method of processing a workpiece with a pulsed laser beam having a wavelength transmittable through the workpiece and a GaN wafer manufacturing method of manufacturing a GaN wafer from a workpiece such as a GaN ingot or a monocrystalline GaN substrate by using such a laser beam, the GaN wafer being thinner than the workpiece.

### Description of the Related Art

There has been developed in the art a method of fabricating a wafer from an ingot by forming a plurality of peel-off layers in the ingot by using a pulsed laser beam, each of the peel-off layers including a modified layer and cracks developed from the modified layer, where the modified layer and cracks are formed at a substantially constant height or vertical position, and then peeling off a wafer from the ingot along the peel-off layers that are of a reduced mechanical strength as separation initiating points (see, for example, JP 2016-111143A).

For forming a peel-off layer in the ingot according to the method, while the pulsed laser beam whose wavelength is transmittable through the ingot has its focused spot positioned within the ingot, the focused spot and the ingot are processing-fed relatively to each other in a predetermined direction perpendicular to thicknesswise directions of the ingot. Thus, a peel-off layer is formed inside the ingot. After the peel-off layer has been formed in the ingot, the focused spot and the ingot are indexing-fed relatively to each other in a direction perpendicular to the predetermined direction. Then, the focused spot and the ingot are processing-fed relatively to each other again during which the laser beam is applied to the ingot, forming another peel-off layer next to the previous peel-off layer in the ingot. The above process is repeated until a plurality of peel-off layers extending in the predetermined direction are formed in the ingot.

Another peel-off method developed in the art is addressed to the processing of a laminated wafer including a first wafer and a second wafer that are stacked one on the other. According to the peel-off method, a plurality of peel-off layers extending in a predetermined direction are formed in the first wafer. Then, the first wafer is separated into two disks along the peel-off layers that act as separation initiating points (see, for example, JP 2023-26825A). For forming a peel-off layer in the ingot according to the peel-off method, while the focused spot of a pulsed laser beam whose wavelength is transmittable through the first wafer is positioned within the first wafer, the focused spot and the first wafer are processing-fed relatively to each other in a predetermined direction perpendicular to the thicknesswise directions of the first wafer.

When a laser beam is applied to an outer peripheral area of a workpiece such as an ingot or a laminated wafer, part of the laser beam tends to enter the workpiece via a face side thereof, and another part of the laser beam tends to enter the workpiece via an outer peripheral side surface thereof.

The part of the laser beam that has entered the workpiece via the face side thereof and the other part of the laser beam that has entered the workpiece via the outer peripheral side surface thereof have respective focused spots formed at different positions thicknesswise in the workpiece due to the different refractive indexes of mediums inside and outside of the workpiece.

Consequently, different laser beam intensities (W/cm²) are likely to occur at one depthwise position in the workpiece. In addition, the outer peripheral side surface of the workpiece is liable to reflect or disperse the part of the laser beam applied thereto. Therefore, the depthwise positions of modified layers and the manner in which the modified layers are formed in the outer peripheral area of the workpiece tend to be different from those in a central area of the workpiece. An additional problem is that, in the outer peripheral area of the workpiece, cracks developed from the modified layers may possibly extend in unexpected directions. SUMMARY OF THE INVENTION

In view of the above difficulties encountered in the related art, it is an object of the present invention to reduce adverse effects of a laser beam that enters a workpiece via an outer peripheral side surface thereof when the laser beam is applied to the workpiece to form modified layers in the workpiece.

In accordance with an aspect of the present invention, there is provided a laser processing method including a mask preparing step of adjusting a masking unit for masking part of a pulsed laser beam having a wavelength transmittable through a column-shaped or plate-shaped workpiece that has a first surface, a second surface opposite the first surface, and an outer peripheral side surface traversing the first surface and the second surface, when the laser beam is applied to an outer peripheral area of the workpiece in a direction from the first surface to the second surface, such that part of the laser beam that enters the workpiece via the outer peripheral side surface has an intensity smaller than a processing threshold value of the workpiece, and after the mask preparing step, a laser beam applying step of, having adjusted a height of a focused spot of the laser beam to position the focused spot within the workpiece, moving the focused spot and the workpiece relatively to each other so as to move the focused spot along the outer peripheral area, thereby forming a modified layer in the workpiece while masking, with the masking unit, the part of the laser beam that enters the workpiece via the outer peripheral side surface such that the part of the laser beam has the intensity smaller than the processing threshold value of the workpiece.

Preferably, the masking unit has a spatial light phase modulator for at least partly modulating the laser beam or a metal mask for partly masking the laser beam, and the laser beam applying step includes masking the part of the laser beam by at least partly modulating the laser beam with the spatial light phase modulator to weaken the intensity of the laser beam or physically masking the part of the laser beam with the metal mask.

Preferably, the laser beam applying step includes causing another part of the laser beam that has not been masked by the masking unit to branch into a plurality of focused spots arrayed in a predetermined direction that traverses, in a plan view of the workpiece, a direction along which the focused spot and the workpiece are moved relatively to each other, and applying the other part of the laser beam to the workpiece.

In accordance with another aspect of the present invention, there is provided a GaN wafer manufacturing method of manufacturing a GaN wafer from a workpiece that is either a GaN ingot or a monocrystalline GaN substrate, the GaN wafer having a thickness smaller than the thickness of the workpiece. The workpiece has a first surface, a second surface opposite the first surface, and an outer peripheral side surface traversing the first surface and the second surface. The GaN wafer manufacturing method includes an outer peripheral area peel-off layer forming step of, having adjusted a height of a focused spot of a pulsed laser beam having a wavelength transmittable through the workpiece so as to position the focused spot within the workpiece, moving the workpiece and the focused spot relatively to each other so as to move the focused spot along an outer peripheral area of the workpiece, thereby forming a peel-off layer in the outer peripheral area, after the outer peripheral area peel-off layer forming step, a central area peel-off layer forming step of moving the focused spot and the workpiece relatively to each other in a central area of the workpiece that is positioned inwardly of the outer peripheral area in a plane of the first surface or the second surface, thereby forming a peel-off layer in the central area, and a peeling step of peeling off a GaN wafer from the workpiece along the peel-off layer in the outer peripheral area and the peel-off layer in the central area, the peel-off layers acting as separation initiating points. The outer peripheral area peel-off layer forming step includes forming the peel-off layer in the workpiece while masking, with a masking unit, part of the laser beam that enters the workpiece via the outer peripheral side surface such that the part of the laser beam has an intensity smaller than a processing threshold value of the workpiece.

Preferably, the masking unit has a spatial light phase modulator for at least partly modulating the laser beam or a metal mask for partly masking the laser beam, and the outer peripheral area peel-off layer forming step includes masking the part of the laser beam by at least partly modulating the laser beam with the spatial light phase modulator to weaken the intensity of the laser beam or physically masking the part of the laser beam with the metal mask.

Preferably, the outer peripheral area peel-off layer forming step includes causing other part of the laser beam that has not been masked by the masking unit to branch into a plurality of focused spots arrayed in a predetermined direction that traverses, in a plan view of the workpiece, a direction along which the focused spot and the workpiece are moved relatively to each other, and applying the other part of the laser beam to the workpiece.

In the laser processing method according to the aspect of the invention, the laser beam applying step forms the modified layer in the workpiece while masking, with the masking unit, the part of the laser beam that enters the workpiece via the outer peripheral side surface such that the part of the laser beam has the intensity smaller than the processing threshold value of the workpiece. Therefore, adverse effects of the laser beam that enters the workpiece via the outer peripheral side surface are reduced.

In the GaN wafer manufacturing method according to the other aspect of the invention, the outer peripheral area peel-off layer forming step forms the peel-off layer in the workpiece while masking, with the masking unit, the part of the laser beam that enters the workpiece via the outer peripheral side surface such that the part of the laser beam has the intensity smaller than the processing threshold value of the workpiece. Therefore, adverse effects of the laser beam that enters the workpiece via the outer peripheral side surface are reduced.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a flowchart illustrating by way of example the sequence of a laser processing method according to a first embodiment of the present invention;

FIG. 2 is a schematic view, partly in block form, illustrating the laser processing apparatus operating in a mask preparing step of the laser processing method;

FIG. 3 is a diagram illustrating by way of example an image representing a modulation pattern displayed by a spatial light phase modulator in the mask preparing step;

FIG. 4A is a schematic view, partly in cross section and block form, illustrating the laser processing apparatus operating in a laser beam applying step of the laser processing method;

FIG. 4B is an enlarged schematic cross-sectional view illustrating a portion of FIG. 4A;

FIG. 5A is an enlarged schematic cross-sectional view illustrating a comparative example in which a laser beam forms in a workpiece a focused spot that is closest to an outer peripheral side surface of the workpiece along a Y-axis;

FIG. 5B is an enlarged schematic cross-sectional view illustrating a comparative example in which a laser beam forms in a workpiece a focused spot that is farthest from the outer peripheral side surface of the workpiece along the Y-axis;

FIG. 6 is a plan view of the workpiece in the laser beam applying step;

FIG. 7A is a diagram illustrating by way of example an image representing a modulation pattern displayed by a spatial light phase modulator in a first comparative experiment;

FIG. 7B is a photographic representation illustrating in plan an outer peripheral area of a workpiece after being processed with a laser beam in the first comparative experiment;

FIG. 8A is a diagram illustrating by way of example an image representing a modulation pattern displayed by a spatial light phase modulator in a second comparative experiment;

FIG. 8B is a photographic representation illustrating in plan an outer peripheral area of a workpiece after being processed with a laser beam in the second comparative experiment;

FIG. 9A is a diagram illustrating by way of example an image representing a modulation pattern displayed by a spatial light phase modulator in a first experiment corresponding to the first embodiment;

FIG. 9B is a photographic representation illustrating in plan an outer peripheral area of a workpiece after being processed with a laser beam in the first experiment corresponding to the first embodiment;

FIG. 10A is a schematic view, partly in cross section, illustrating a laser processing apparatus operating in a mask preparing step according to a modification;

FIG. 10B is a schematic view, partly in cross section, illustrating the laser processing apparatus operating in a laser beam applying step according to the modification;

FIG. 11 is a flowchart illustrating by way of example the sequence of a GaN wafer manufacturing method according to a second embodiment of the present invention;

FIG. 12 is a perspective view of a GaN ingot;

FIG. 13 is a plan view illustrating the GaN ingot in an outer peripheral area peel-off layer forming step of the GaN wafer manufacturing method;

FIG. 14A is an enlarged schematic cross-sectional view illustrating the manner in which a laser beam has a substantial half masked;

FIG. 14B is an enlarged schematic cross-sectional view illustrating the manner in which a laser beam has a substantial half that includes an outer peripheral portion masked;

FIG. 15 is a plan view illustrating the GaN ingot in a central area peel-off layer forming step of the GaN wafer manufacturing method;

FIG. 16A is an elevational view of a peeling apparatus;

FIG. 16B is an elevational view illustrating a GaN ingot and a GaN wafer after a peeling step of the GaN wafer manufacturing method; and

FIG. 17 is a plan view illustrating a monocrystalline GaN substrate shaped as a rectangular plate in the outer peripheral area peel-off layer forming step.

### DETAILED DESCRIPTION OF THE PREFERRED EMBODIMENTS

### First Embodiment

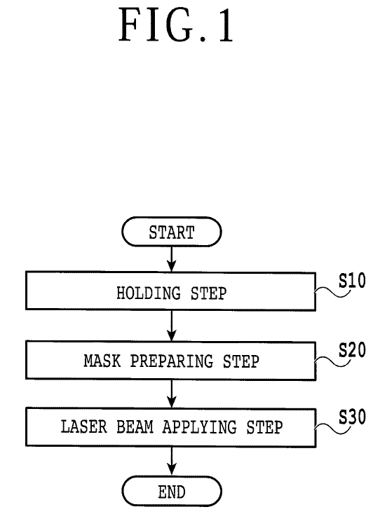

A laser processing method according to a first embodiment of the present invention will be described below with reference to FIGS. 1 through 10B of the accompanying drawings. FIG. 1 is a flowchart illustrating by way of example the sequence of the laser processing method according to the first embodiment. As illustrated in FIG. 1, the laser processing method according to the first embodiment includes holding step S10, mask preparing step S20, and laser beam applying step S30 that are to be carried out successively.

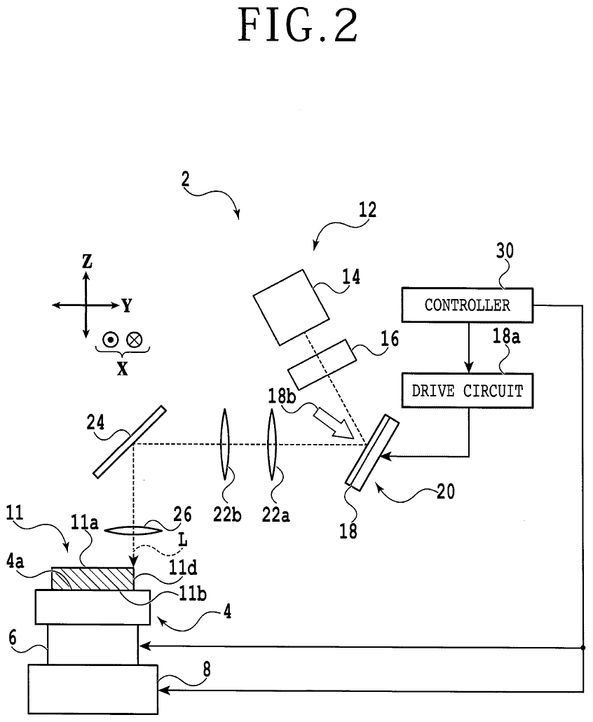

A laser processing apparatus to be used to perform the laser processing method according to the first embodiment will first be described below with reference to FIG. 2. FIG. 2 schematically illustrates the laser processing apparatus, denoted by 2, with some components depicted in block form and simplified configuration. In FIG. 2 and other figures, the laser processing apparatus 2 and some elements are illustrated in reference to a three-dimensional XYZ coordinate system including an X-axis along which processing feed directions extend as horizontal directions, a Y-axis along which indexing feed directions extend as horizontal directions, and a Z-axis along which heightwise directions or vertical directions extend. The X-axis and the Y-axis extend perpendicularly to each other, and the Z-axis extends perpendicularly to the X-axis and the Y-axis.

The laser processing apparatus 2 includes a disk-shaped chuck table 4 having a disk-shaped frame made of a metal material such as stainless steel, for example. The frame has a disk-shaped upwardly open recess, not depicted, defined centrally in an upper surface thereof and smaller in diameter than the frame. A disk-shaped porous plate, not depicted, made of porous ceramic is fixedly fitted in the recess.

The frame has a fluid channel, not depicted, defined therein that is fluidly connected to a suction source, not depicted, such as a vacuum pump through a pipe, not depicted. When the suction source is actuated, it generates and transmits a negative pressure through the fluid channel to the porous plate where the negative pressure acts on an upper surface thereof. The frame has an annular upper surface around the recess, and the porous plate has a circular upper surface lying substantially flush with the annular upper surface of the frame. The annular upper surface of the frame and the circular upper surface of the porous plate extend substantially flatwise and jointly function as a holding surface 4a for holding a workpiece 11 under suction thereon.

The holding surface 4a lies substantially parallel to an XY plane that is defined horizontally along the X-axis and the Y-axis. The chuck table 4 is disposed above and operatively coupled with a rotary drive mechanism 6 for turning the chuck table 4 about its central axis through a desired angle. The central axis of the chuck table 4 extends vertically along the Z-axis.

The chuck table 4 and the rotary drive mechanism 6 are supported on a horizontally moving mechanism 8. The horizontally moving mechanism 8 includes a ball-screw-type X-axis moving mechanism and a ball-screw-type Y-axis moving mechanism for moving the chuck table 4 and the rotary drive mechanism 6 respectively along the X-axis and the Y-axis.

The laser processing apparatus 2 also includes a laser beam applying unit 12 above the holding surface 4a of the chuck table 4. The laser beam applying unit 12 includes a laser oscillator 14 having a laser medium such as neodymium-yttrium-aluminum-garnet (Nd: YAG) or neodymium doped yttrium orthovanadate (ND: YVO₄), for example. The laser oscillator 14 has an exciting light source, not depicted, such as a lamp for applying exciting light to the laser medium and a Q switch, not depicted, for controlling the timing to emit a laser beam L from the laser beam applying unit 12.

The laser oscillator 14 generates the laser beam L, which is a pulsed laser beam having a wavelength of 1064 nm, for example, transmittable through the workpiece 11 if the workpiece 11 is made of GaN. In FIG. 2, the laser beam L emitted from the laser oscillator 14 travels along a path indicated by the broken lines in the laser beam applying unit 12.

The laser beam L generated by the laser oscillator 14 is converted into a burst-mode laser beam L by an acousto-optic modulator (AOM), not depicted, that operates according to an electric signal applied thereto.

The acousto-optic modulator functions to deflect the laser beam L at predetermined time intervals according to the applied electric signal. Specifically, the acousto-optic modulator converts the laser beam L into the burst-mode laser beam L that includes repetitive groups of beam pulses occurring at predetermined periodic intervals by decimating pulses from the laser beam L.

According to the present embodiment, the number of beam pulses included in one burst of pulses is referred to as “burst number.” The burst number may be 10, for example, but is not necessarily limited to 10. The spacing between pulse bursts ranges from several tens of microseconds to several hundreds of microseconds, for example, and the repetitive frequency of pulse bursts is 50 kHz, for example. The burst-mode laser beam L emitted from the laser oscillator 14 is applied to an output regulator 16 having an attenuator, for example, that regulates the output level of the burst-mode laser beam L. Thereafter, the burst-mode laser beam L, hereinafter also referred to simply as a “laser beam L”, from the output regulator 16 is applied to a liquid crystal on silicon-spatial light modulator (LCOS-SLM), hereinafter referred to as the “spatial light phase modulator 18.”

The spatial light phase modulator 18 according to the present embodiment is a reflection type liquid crystal device though it may be a transmission type liquid crystal device. The spatial light phase modulator 18 has a function to change the phase, plane of polarization, amplitude, intensity, and direction of propagation of the laser beam L applied thereto, i.e., to modulate the laser beam L.

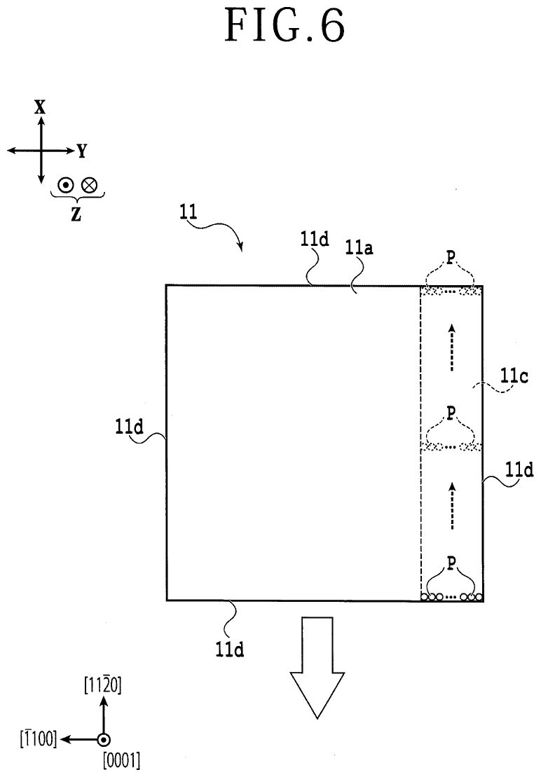

The laser beam applying unit 12 applies the laser beam L to an outer peripheral area 11c (see FIG. 6) of the workpiece 11 held under suction on the holding surface 4a along a direction from an upper surface, i.e., a first surface, 11a of the workpiece 11 to a lower surface, i.e., a second surface, 11b of the workpiece 11. When the laser beam applying unit 12 thus applies the laser beam L to the outer peripheral area 11c of the workpiece 11, the spatial light phase modulator 18 changes the phase of the laser beam L, for example. Specifically, the spatial light phase modulator 18 changes the phase of the laser beam L such that part of the laser beam L that enters the workpiece 11 via an outer peripheral side surface 11d thereof has an intensity smaller than a processing threshold value of the workpiece 11, thereby masking the part of the laser beam L.

According to the present embodiment, providing part of the laser beam L has an intensity smaller than the processing threshold value of the workpiece 11, the part of the laser beam L is phrased as “masked.” The masked part of the laser beam L is completely blocked or interrupted, for example. At this time, the intensity (W/cm²) or energy (J) of the masked part of the laser beam L is essentially zero.

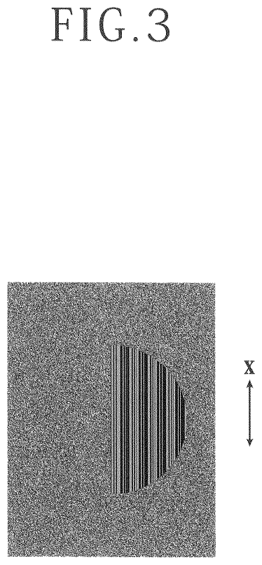

By way of example, the spatial light phase modulator 18 modulates at least part of the laser beam L to reduce the intensity thereof in the vicinity of a focused spot of the laser beam L, using a portion of an irradiated region of the spatial light phase modulator 18 that is irradiated with the laser beam L except a particular semicircular region (see a semicircular region having a striped pattern in FIG. 3).

In this manner, the flux of the laser beam L has a substantial half, i.e., part thereof, on a cross-sectional plane lying perpendicularly to the direction along which the laser beam L travels, masked in the vicinity of the focused spot thereof. Stated otherwise, a spatial energy distribution of the laser beam L is adjusted such that the intensity of the substantial half of the flux of the laser beam L is less than the processing threshold value of the workpiece 11, e.g., essentially zero, in the vicinity of the focused spot of the laser beam L. The flux of the modulated laser beam L may not necessarily be masked to the substantial half, but may be masked to various extents depending on the manner in which the workpiece 11 is processed by the laser beam L. The spatial light phase modulator 18 changes the phase of the laser beam L, for example, to adjust the energy distribution thereof as described above and also causes the laser beam L to branch into a plurality of focused spots P (see FIG. 6).

According to the present embodiment, the laser beam L is caused to branch into ten focused spots P arrayed along the Y-axis. However, the number of branches into which the laser beam L is divided is not limited to 10, but may be adjusted depending on the average output level, repetitive frequency, and other variables of the laser beam L, and a size of the workpiece.

As described above, the spatial light phase modulator 18 has a function to mask part of the laser beam L and a function to cause the laser beam L to branch into a plurality of focused spots. The spatial light phase modulator 18 is controlled for its operation by a drive circuit 18a (see FIG. 2) to be described later. The drive circuit 18a is in turn controlled for its operation by a controller 30 (see also FIG. 2) to be described later. The spatial light phase modulator 18 has a display area including a matrix of pixels. The display area has a liquid crystal layer that provides a predetermined pattern when the tilt of liquid crystal molecules in each pixel of the liquid crystal layer is controlled by the drive circuit 18a. The phase of the laser beam L, for example, is changed depending on the pattern of the liquid crystal layer.

The spatial light phase modulator 18 makes up a masking unit 20 according to the present embodiment. In the masking unit 20 according to the present embodiment, the spatial light phase modulator 18 performs the function to mask part of the laser beam L and a function to cause the laser beam L to branch into a plurality of focused spots. In a mask unit according to a modification, however, the function to mask part of the laser beam L may be performed by a metal mask rather than the spatial light phase modulator 18. If the masking unit 20 has such a metal mask, the spatial light phase modulator 18 performs the function to cause the laser beam L to branch into a plurality of focused spots. However, the function to cause the laser beam L to branch into a plurality of focused spots may be performed by a diffraction optical element (DOE) rather than the spatial light phase modulator 18.

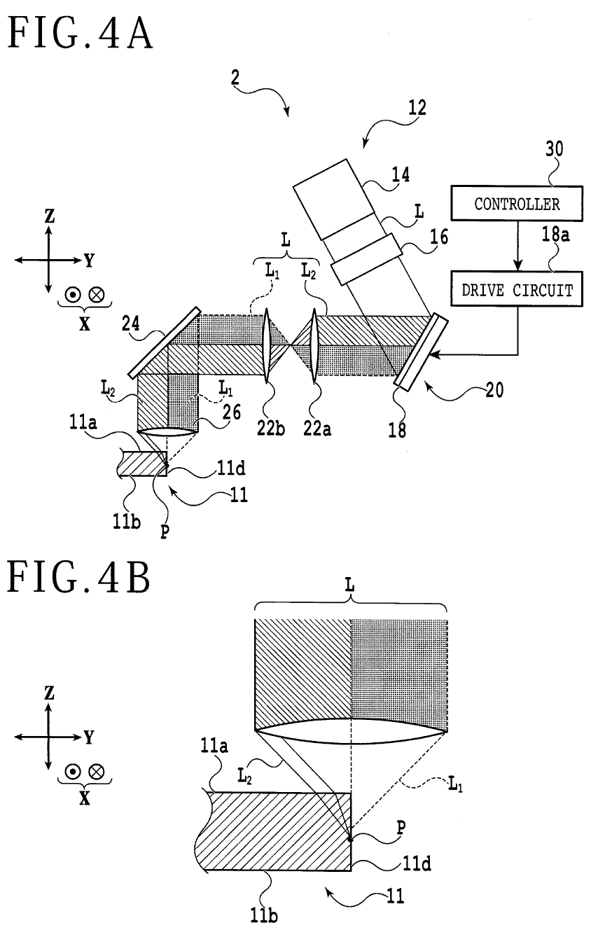

As illustrated in FIG. 2, the laser beam L that has traveled via the spatial light phase modulator 18 passes through a pair of lenses 22a and 22b. The lenses 22a and 22b have respective axes substantially aligned with each other parallel to the Y-axis. In FIG. 2, the lenses 22a and 22b have their positions and focal lengths illustrated generally by way of example. The laser beam L as it travels through the lenses 22a and 22b is adjusted in beam diameter and inverted along the Z-axis and the X-axis, as illustrated in FIG. 4A, reflected by a mirror 24, and then applied to a condensing lens 26.

The mirror 24 and the condensing lens 26 are fixedly mounted in a tubular beam condenser, not depicted. The laser beam applying unit 12 is vertically movable along the Z-axis by a ball-screw-type Z-axis moving mechanism, not depicted. When the laser beam applying unit 12 is moved along the Z-axis, the positions of the focused spots of the laser beam L along the Z-axis are adjusted. The condensing lens 26 may be movably mounted for movement along the Z-axis in the beam condenser.

The laser beam L that has passed through the condensing lens 26 is applied to the workpiece 11 held under suction on the holding surface 4a. According to the present embodiment, the workpiece 11 is in the form of a monocrystalline substrate made of a single crystal of gallium nitride (GaN) and shaped as a rectangular plate (see FIG. 6). The upper surface 11a and the lower surface 11b of the workpiece 11 are positioned opposite each other in the thicknesswise directions of the workpiece 11. The outer peripheral side surfaces 11d of the workpiece 11 is joined perpendicularly to, i.e., traverses, the upper surface 11a and the lower surface 11b of the workpiece 11. As the workpiece 11 is shaped as a rectangular plate according to the present embodiment, the outer peripheral side surfaces 11d have four flat surfaces (e.g., facets) each extending substantially flatwise (see FIG. 6).

As depicted in FIG. 2, a microscope camera unit, not depicted, that is movable along the Z-axis in unison with the laser beam applying unit 12 is disposed in the vicinity of the beam condenser. The microscope camera unit has a light source such as a light-emitting diode (LED) and a solid-state image capturing device such as a charge-coupled device (CCD) image sensor or a complementary metal-oxide-semiconductor (CMOS) image sensor.

The chuck table 4, the rotary drive mechanism 6, the horizontally moving mechanism 8, the laser oscillator 14, and the drive circuit 18a are controlled for their operation by the controller 30. The controller 30 is implemented by a computer including a processor, i.e., a processing device, typified by a central processing unit (CPU) and a memory, i.e., a storage device, for example. The memory includes a main storage unit such as a dynamic random access memory (DRAM) and an auxiliary storage unit such as a flash memory. The auxiliary storage unit stores software including predetermined programs. When the processor and the memory are operated according to the software stored in the auxiliary storage unit, the controller 30 has its functions performed to operate the laser processing apparatus 2.

Next, a process of processing the workpiece 11 with the laser beam L according to the laser processing method illustrated in FIG. 1 will be described below. As illustrated in FIG. 2, the workpiece 11 is placed on the chuck table 4 with the lower surface 11b in contact with the holding surface 4a, and then held under suction on the holding surface 4a (holding step S10). Then, using the microscope camera unit, the orientation of the chuck table 4 is adjusted to direct two parallel opposite surfaces of the outer peripheral side surfaces 11d of the workpiece 11 substantially parallel to the X-axis, as illustrated in FIG. 6.

Then, in preparation for the application of the laser beam L to the workpiece 11, the spatial light phase modulator 18, i.e., the masking unit 20, is adjusted to mask part of the laser beam L that enters the workpiece 11 via one of the two parallel opposite surfaces of the outer peripheral side surfaces 11d and to cause the remaining unmasked part of the laser beam L to branch into a plurality of focused spots P at a position near the focused spots P (mask preparing step S20). The one of the two parallel opposite surfaces of the outer peripheral side surfaces 11d referred to above will hereinafter also be referred to as the “outer peripheral side surface 11d.”

FIG. 2 illustrates the laser processing apparatus 2 that operates in mask preparing step S20. In mask preparing step S20, the controller 30 sends a predetermined signal according to the standards of a video input/output interface such as a digital visual interface (DVI) to the drive circuit 18a. In response to the signal, the drive circuit 18a energizes the spatial light phase modulator 18 to control the tilt of liquid crystal molecules in each pixel of the liquid crystal layer to cause the liquid crystal layer to provide a predetermined pattern.

FIG. 3 illustrates, by way of example, an image representing a modulation pattern provided as the predetermined pattern and displayed by the spatial light phase modulator 18 in mask preparing step S20. In the modulation pattern illustrated in FIG. 3, each pixel of the liquid crystal layer of the spatial light phase modulator 18 represents a phase change ranging from 0 [rad] to 2π [rad] to be given to the laser beam L in a grayscale. However, the modulation pattern itself is almost invisible to the human eye when the operator sees the spatial light phase modulator 18.

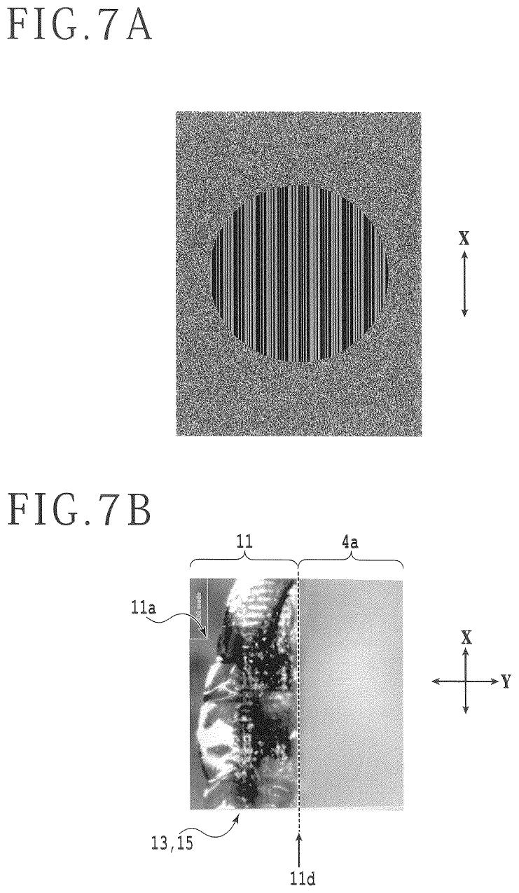

When the phase change that each pixel of the liquid crystal layer gives to the laser beam L is converted into an 8-bit pixel value, e.g., a luminance value, the modulation pattern displayed by the pixels of the spatial light phase modulator 18 as viewed along the arrow 18b in FIG. 2 is represented by the image illustrated in FIG. 3. Images illustrated in FIGS. 7A, 8A, and 9A are also representative of modulation patterns thus converted.

Holding step S10 and mask preparing step S20 may be switched around, i.e., they may be carried out in any order, or may be carried out simultaneously. After holding step S10 and mask preparing step S20, the laser oscillator 14 generates and emits the laser beam L that travels via the spatial light phase modulator 18, the lenses 22a and 22b, the mirror 24, and the condensing lens 26 to the workpiece 11 on the holding surface 4a (laser beam applying step S30).

FIG. 4A schematically illustrates, partly in block form, the laser processing apparatus 2 operating in laser beam applying step S30, and FIG. 4B schematically illustrates a portion of FIG. 4A at an enlarged scale near a focused spot P. Since the workpiece 11 according to the present embodiment, i.e., a monocrystalline substrate of GaN, has no off-angle, the upper surface 11a is represented by (0001) and the thicknesswise directions thereof extend parallel to. The outer peripheral side surface 11d is represented by {−1100} or {11-20}.

In the present description, the workpiece 11 has crystal surfaces and orientations designated by Miller-Bravais indices. Particular crystal surfaces are represented using ( ), and crystal surfaces that are equivalent to each other owing to the symmetry of the crystal structure are represented using { }. Similarly, particular crystal orientations are represented using [ ], and crystal orientations that are equivalent to each other are represented using < >. An index accompanied by a negative sign is equal to an index with an overbar.

In FIGS. 4A and 4B, the part of the laser beam L that enters the workpiece 11 via the upper surface 11a thereof is depicted hatched, whereas the part of the laser beam L that is directed to enter the workpiece 11 via the outer peripheral side surface 11d thereof, but is actually masked by the masking unit 20 is depicted stippled. In FIGS. 4A and 4B, the laser beam L is not depicted as branching into a plurality of focused dots P along the Y-axis, but is in practice caused to branch into a plurality of focused dots P along the Y-axis (see FIG. 6) according to the present embodiment. The Y-axis extends perpendicularly to, i.e., traverses, the X-axis along which the focused spots P and the workpiece 11 are moved relatively to each other, as viewed in plan.

FIGS. 4A and 4B illustrate a first component L₁ of the laser beam L as the part of the laser beam L that is directed to enter the workpiece 11 via the outer peripheral side surface 11d thereof, but is actually masked by the masking unit 20, and a second component L₂ of the laser beam L as the part of the laser beam L that enters the workpiece 11 via the upper surface 11a thereof. The first component L₁ has been so modulated as to weaken itself, whereas the second component L₂ has been so modulated as to intensify, rather than weaken, itself.

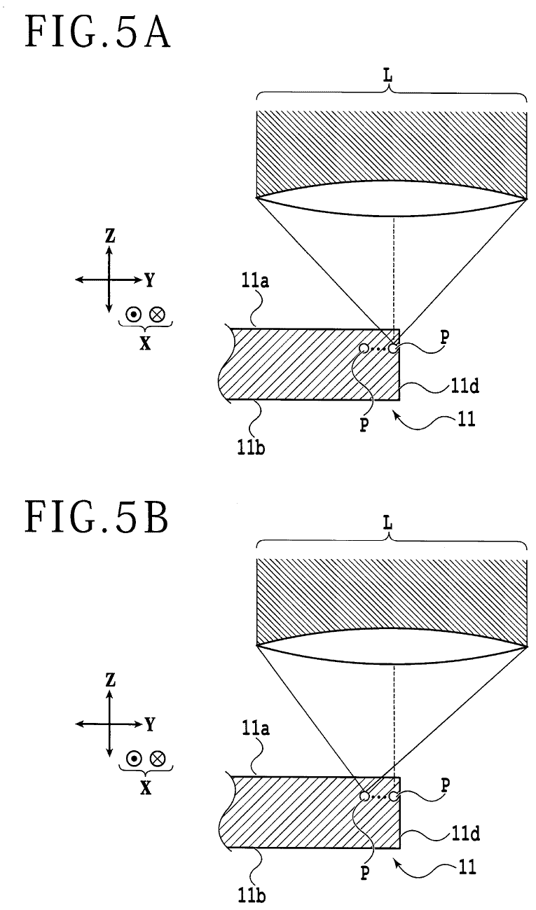

FIGS. 5A and 5B illustrate comparative examples, respectively. In each of the illustrated comparative examples, a laser beam L that is not masked is caused to branch into a plurality of focused spots P at a position near the focused spots P in a workpiece 11 when an outer peripheral area 11c (see FIG. 6) of the workpiece 11 is processed with the laser beam L. FIGS. 5A and 5B illustrate by way of example the focused spots P that are arrayed in the workpiece 11 along the Y-axis at a predetermined depth in the workpiece 11. FIG. 5A illustrates the laser beam L as it forms in the workpiece 11 a focused spot P that is closest to the outer peripheral side surface 11d of the workpiece 11 along the Y-axis.

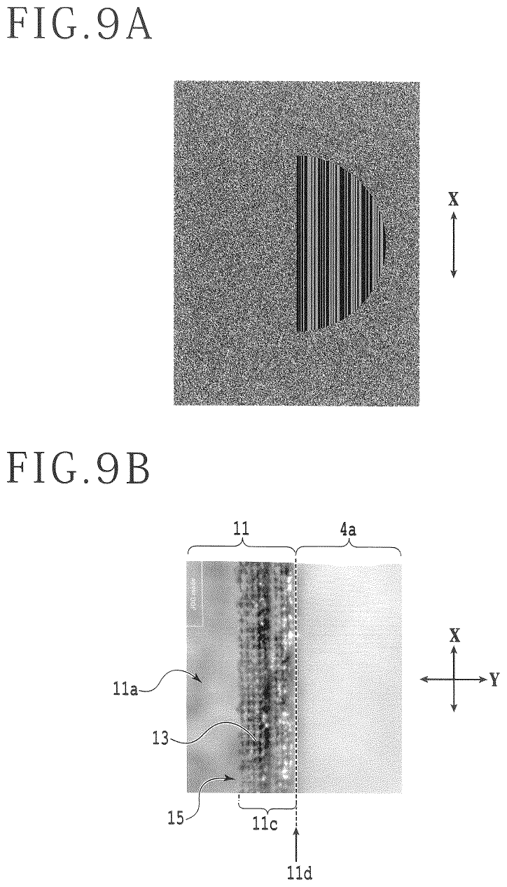

In FIG. 5A, a modified layer 13 (see, for example, FIG. 9B) may not be formed in the workpiece 11 near the outer peripheral side surface 11d thereof or, even if a modified layer 13 is formed, cracks developed from the modified layer 13 may extend in unexpected directions, due to the different refractive indices of mediums inside and outside of the workpiece 11 with respect to the laser beam L applied to the outer peripheral side surface 11d and reflection and scattering of the laser beam L from the outer peripheral side surface 11d.

FIG. 5B illustrates the laser beam L as it forms in the workpiece 11 a focused spot P that is farthest from the outer peripheral side surface 11d of the workpiece 11 along the Y-axis. In FIG. 5B, the laser beam L is not applied to the outer peripheral side surface 11d, but enters the workpiece 11 via the upper surface 11a thereof.

As can be seen from FIGS. 5A and 5B, when the laser beam L is applied to the outer peripheral area 11c of the workpiece 11, the laser beam L may enter the workpiece 11 via the outer peripheral side surface 11d. According to the present embodiment, the laser beam L is modulated such that the laser beam L is prevented from entering the workpiece 11 via the outer peripheral side surface 11d.

In laser beam applying step S30 according to the present embodiment, as illustrated in FIGS. 4A and 4B, the spatial light phase modulator 18, i.e., the masking unit 20, masks the first component L₁ of the laser beam L, i.e., part of the laser beam L, that enters the workpiece 11 via the outer peripheral side surface 11d. Furthermore, the spatial light phase modulator 18 causes the second component L₂ of the laser beam L, i.e., other part of the laser beam L, that is not masked but enters the workpiece 11 via the upper surface 11a to branch into a plurality of focused spots P arrayed along the Y-axis in the workpiece 11 at a position near the focused spots P. With the height or vertical position of the focused spots P being adjusted to keep the focused spots P of the second component L₂ within the workpiece 11, the focused spots P and the workpiece 11 are moved relatively to each other to move the focused spots P in the workpiece 11 along the outer peripheral area 11c of the workpiece 11 (see FIG. 6).

FIG. 6 illustrates, in plan, the workpiece 11 in laser beam applying step S30. According to the present embodiment, while the ten focused spots P are being arrayed along the Y-axis in the workpiece 11, the chuck table 4 is processing-fed along the X-axis, thereby moving the focused spots P and the workpiece 11 relatively to each other. At this time, as described above, the first component L₁ of the laser beam L that enters the workpiece 11 via one of the outer peripheral side surface 11d is masked by the spatial light phase modulator 18. The focused spots P that are moving relatively to the workpiece 11 form a modified layer 13 inside of the workpiece 11 and along the outer peripheral area 11c of the workpiece 11.

Laser beam applying step S30 is carried out under the following processing conditions. The focused spot P that is closest to the outer peripheral side surface 11d of the workpiece 11 along the Y-axis is spaced from the outer peripheral side surface 11d by a predetermined distance, e.g., 6 μm, equal to or less than a half of the distance between adjacent two of the focused spots P.
Wavelength: 1064 μm
Average output power: 2.6 W
Repetitive frequency: 50 kHz
Number of branches: 10
Distance between focused spots: 12.5 μm
Depth of focused spots: 170 μm from the upper surface 11a
Diameter of focused spots: 5 μm
Number of passes: 1
Burst number: 10
Processing feed speed: 875 mm/s

According to the present embodiment, in laser beam applying step S30, while the masking unit 20 is masking the first component L₁ such that the intensity of the first component L₁ is smaller than the processing threshold value of the workpiece 11, the laser beam applying unit 12 forms a modified layer 13 in the workpiece 11. Consequently, the adverse effects of the first component L₁ that enters the workpiece 11 via the outer peripheral side surface 11d are reduced.

### (Experiments)

The results of experiments conducted to process rectangular monocrystalline substrates of GaN with laser beams will be described below with reference to FIGS. 7A through 9B. In the experiments illustrated in FIGS. 7A through 9B, the outer peripheral side surface 11d of the workpiece 11 as viewed in plan may be referred to as “edge.” In the experiments, the outer peripheral area 11c of the workpiece 11, i.e., one side portion of the rectangular workpiece 11, was processed with the laser beam under the processing conditions referred to above, except for the average output power, and irrespectively of whether the laser beam was partly masked or not.

FIGS. 7A and 7B are illustrative of a first comparative experiment. In the first comparative experiment, a rectangular workpiece 11 was processed with a laser beam L that had an average output power of 2.6 W, as with the above processing conditions, and that was not masked by the spatial light phase modulator 18. The laser beam L that formed one or more focused spots P in the workpiece 11 near an outer peripheral side surface 11d thereof entered the workpiece 11 partly via the peripheral side surface 11d (see, for example, FIG. 5A). The focused spots P had substantially the same intensities.

FIG. 7A specifically illustrates, by way of example, an image representing a modulation pattern displayed by the spatial light phase modulator 18 in the first comparative experiment. FIG. 7B is a photographic representation illustrating in plan an outer peripheral area 11c of the workpiece 11 after being processed with the laser beam L in the first comparative experiment.

A broken line that extends vertically across the center of the image illustrated in FIG. 7B represents the edge, i.e., the outer peripheral side surface 11d, of the workpiece 11. As illustrated in FIG. 7B, the outer peripheral area 11c of the workpiece 11 that is positioned to the left of the edge has a peel-off layer 15 formed therein that includes a modified layer 13 and cracks, whose reference character is omitted from illustration in FIG. 7B. As illustrated in FIG. 7B, the peel-off layer 15 is formed somewhat irregularly in a plane parallel to the upper surface 11a of the workpiece 11 and has various different depths or vertical positions in the thicknesswise directions of the workpiece 11.

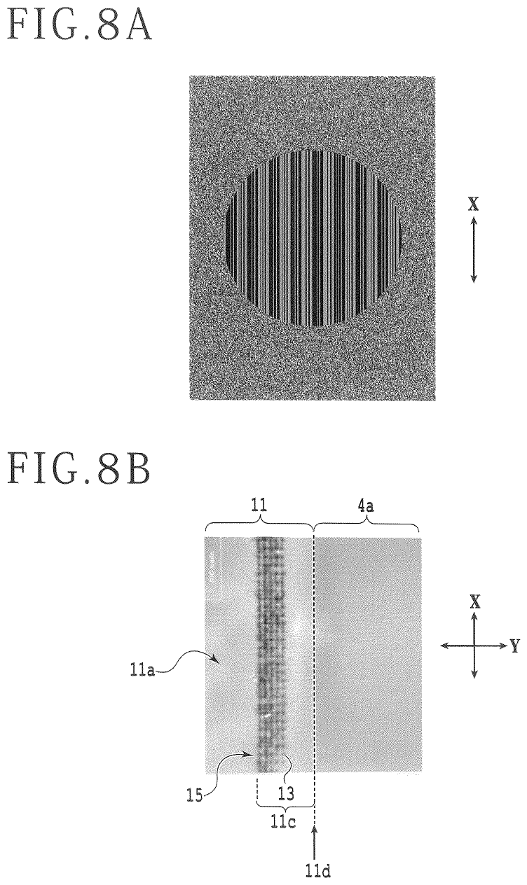

FIGS. 8A and 8B are illustrative of a second comparative experiment. In the second comparative experiment, an outer peripheral area 11c of a rectangular workpiece 11, i.e., one side portion of the workpiece 11, was processed with a laser beam L that had an average output power of 1.3 W, i.e., half of the average output power of the laser beam in the first comparative example, and that was not masked by the spatial light phase modulator 18.

The laser beam L that formed one or more focused spots P in the workpiece 11 near an outer peripheral side surface 11d thereof entered the workpiece 11 partly via the peripheral side surface 11d. The focused spots P had substantially the same intensities, which were approximately half of the intensities of the focused spots P in the first comparative experiment.

FIG. 8A specifically illustrates, by way of example, an image representing a modulation pattern displayed by the spatial light phase modulator 18 in the second comparative experiment. FIG. 8B is a photographic representation illustrating in plan the outer peripheral area 11c of the workpiece 11 after being processed with the laser beam L in the second comparative experiment. A broken line that extends vertically across the center of the image illustrated in FIG. 8B represents the edge, i.e., the outer peripheral side surface 11d, of the workpiece 11.

As illustrated in FIG. 8B, the workpiece 11 has a modified layer 13 formed in an outer peripheral area 11c and along a first strip area slightly spaced from the edge of the workpiece 11. Cracks are developed from the modified layer 13. The modified layer 13 and the cracks jointly make up a peel-off layer 15. However, no modified layer is formed in a second strip area that is closer to the edge of the workpiece 11 than the first strip area. It is considered that no modified layer is formed in the second strip area because the intensity of the laser beam L applied to form one or more focused spots P in the workpiece 11 near the outer peripheral side surface 11d has not reached the processing threshold value for forming a modified layer 13 due to the different refractive indices of mediums inside and outside of the workpiece 11 with respect to the laser beam L applied to the outer peripheral side surface 11d and reflection and scattering of the laser beam L from the outer peripheral side surface 11d.

FIG. 9A illustrates, by way of example, an image representing a modulation pattern displayed by the spatial light phase modulator 18 in a first experiment according to the first embodiment, and FIG. 9B is a photographic representation illustrating in plan the outer peripheral area 11c of the workpiece 11 after being processed with the laser beam L. According to the first experiment, the processing conditions described according to the first embodiment were employed. In the first experiment, the laser beam L entered the workpiece 11 through the upper surface 11a thereof to form one or more focused spots P positioned in the workpiece 11 near the outer peripheral side surface 11d thereof while part of the laser beam L that enters the workpiece 11 via the outer peripheral side surface 11d was being masked.

A broken line that extends vertically across the center of the image illustrated in FIG. 9B represents the edge of the workpiece 11. The outer peripheral area 11c of the workpiece 11 illustrated in FIG. 9B has a modified layer 13, indicated by black dots, regularly formed in a strip area starting from the edge and having a predetermined width along the Y-axis. The modified layer 13 and cracks developed therefrom jointly make up a peel-off layer 15 at a substantially constant height or vertical position in the thicknesswise directions of the workpiece 11. The laser processing method according to the first embodiment is thus able to form the peel-off layer 15 in the strip area in the outer peripheral area 11c that extends up to the edge of the workpiece 11 by reducing the adverse effects of the first component L₁ of the laser beam L.

### (Modification)

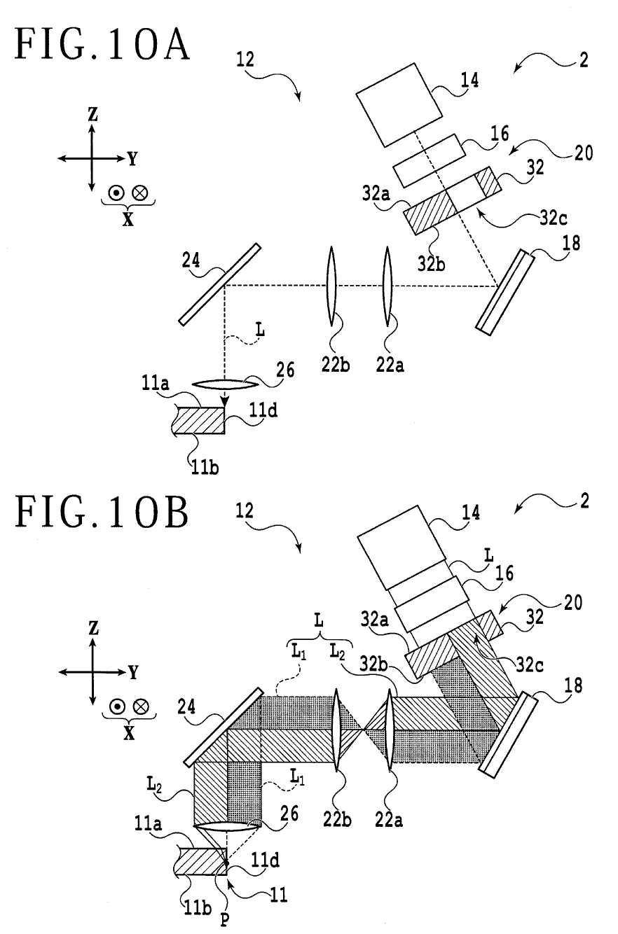

A modification of the first embodiment will be described below with reference to FIGS. 10A and 10B. A masking unit 20 according to the modification has a mask 32 made of metal such as aluminum in its entirety. However, the mask 32 may alternatively be made of another metal material such as stainless steel or Invar having a low coefficient of thermal expansion in its entirety as long as it can mask the laser beam L. The mask 32 may further be of a laminated structure including a glass substrate and a thin film of chromium.

The mask 32 has an opening 32c that extends therethrough from a surface 32a to an opposite surface 32b. As the surface 32a is viewed in plan, the opening 32c is of a semicircular shape that is identical in size and shape to the semicircular pattern illustrated in FIG. 3, for example. The mask 32 allows part of the laser beam L to be transmitted through the opening 32c and physically mask other part of the laser beam L with another portion of the mask 32 than the opening 32c. Therefore, the mask 32 essentially blocks or interrupts the other part of the laser beam L. According to the present modification, the mask 32 performs a function to partly mask the laser beam L, whereas the spatial light phase modulator 18 performs a function to cause the laser beam L that has passed unmasked through the opening 32c to branch into a plurality of laser beams. The spatial light phase modulator 18 may be replaced with a DOE.

FIG. 10A schematically illustrates a laser processing apparatus 2 operating in mask preparing step S20 according to the modification. FIG. 10B schematically illustrates the laser processing apparatus 2 operating in laser beam applying step S30 according to the modification. In FIGS. 10A and 10B, the mask 32 is depicted in cross section and some of the components of the laser processing apparatus 2 that are identical to those of the laser processing apparatus 2 according to the first embodiment are omitted from illustration for illustrative purposes. According to the modification, the laser beam L applied to the workpiece 11 can form a modified layer 13 in the workpiece 11 while part of the laser beam L, i.e., the first component L₁, that enters the workpiece 11 via the outer peripheral side surface 11d is being masked by the masking unit 20.

According to the first embodiment and the modification thereof, the laser beam L is caused to branch into a plurality of focused spots P. However, as long as the part of the laser beam L that enters the workpiece 11 via the outer peripheral side surface 11d is masked, the laser beam L may not be caused to branch into a plurality of focused spots P.

The workpiece 11 is not limited to a monocrystalline substrate shaped as a rectangular plate, and may be a monocrystalline substrate shaped as a disk plate. The monocrystalline substrate may be a bare substrate or a crystalline substrate having a monocrystalline substrate as a seed crystal and an epitaxial growth layer grown on the monocrystalline substrate. Further alternatively, the workpiece 11 may be a cylindrical ingot rather than a monocrystalline substrate.

The material of the workpiece 11 is not limited to GaN, and may be a semiconductor material such as silicon (Si), silicon carbide (SiC), or gallium arsenide (GaAs), for example. If the workpiece 11 is a cylindrical ingot or a disk-shaped monocrystalline substrate, then it has a substantially cylindrical outer peripheral side surface 11d. The substantially cylindrical outer peripheral side surface 11d may have a flat surface or a notch, for example, functioning as an orientation flat.

### Second Embodiment

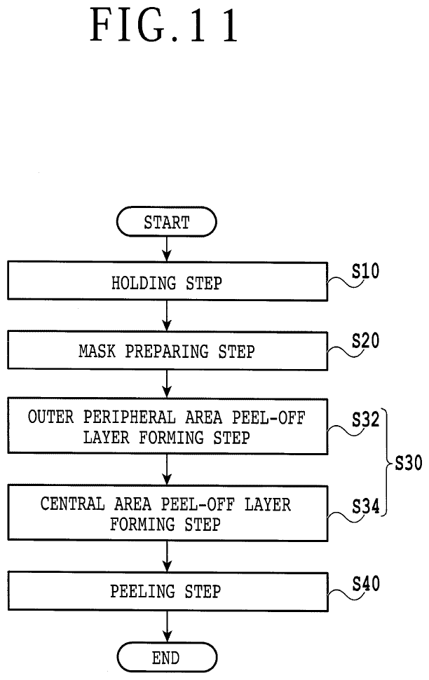

A GaN wafer manufacturing method according to a second embodiment of the present invention will be described below with reference to FIGS. 11 through 16B of the accompanying drawings. The GaN wafer manufacturing method according to the second embodiment refers to a method of manufacturing a GaN wafer 27 by forming peel-off layers 15 in a cylindrical GaN ingot 21 as a workpiece and then peeling off a GaN wafer 27 from the GaN ingot 21 along the peel-off layers 15 as separation initiating points.

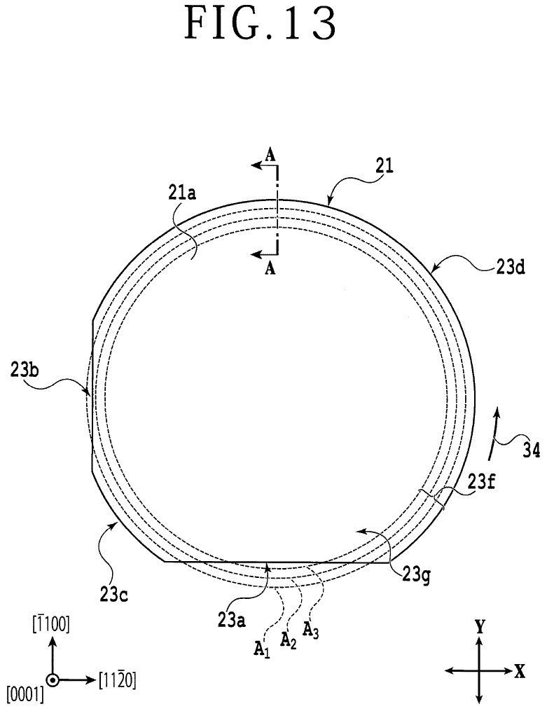

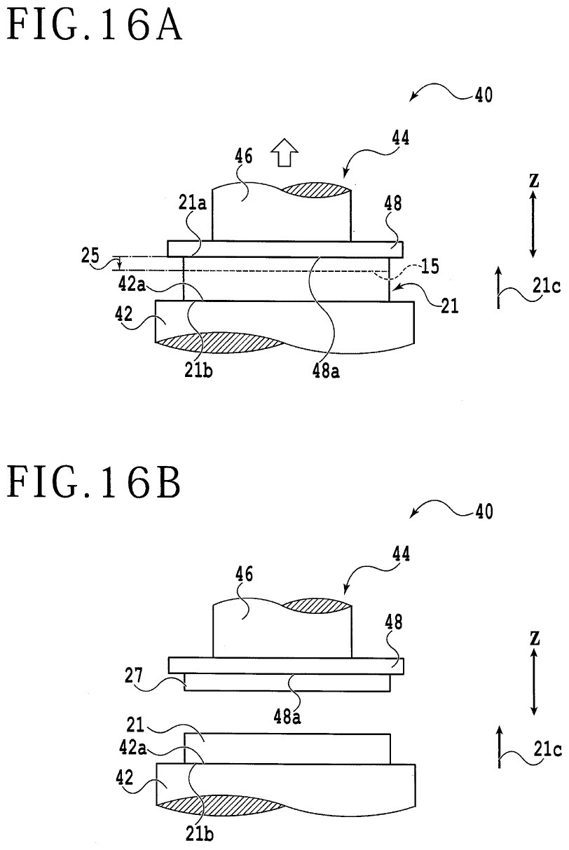

FIG. 11 is a flowchart illustrating by way of example the sequence of the GaN wafer manufacturing method according to the second embodiment. As illustrated in FIG. 11, the GaN wafer manufacturing method includes holding step S10, mask preparing step S20, laser beam applying step S30, and peeling step S40 that are to be carried out successively. According to the second embodiment, holding step S10, mask preparing step S20, and laser beam applying step S30 are carried out by the laser processing apparatus 2 described above (see FIGS. 13 through 15), after which peeling step S40 is carried out by a peeling apparatus 40 (see FIG. 16A).

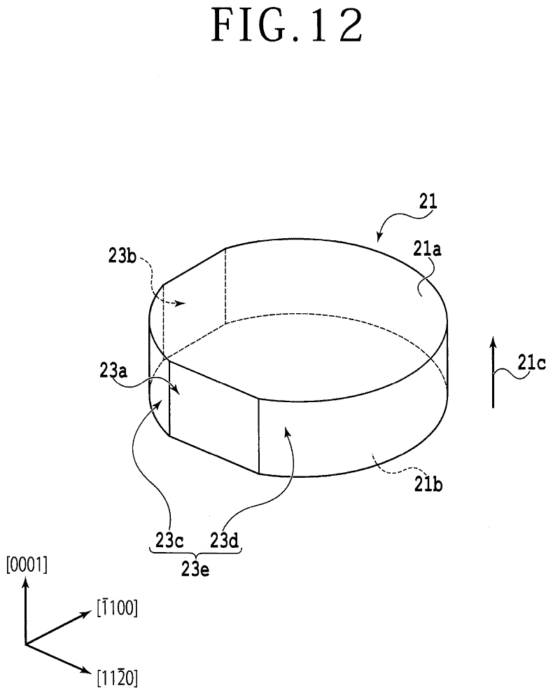

First, the cylindrical GaN ingot 21 to be processed will be described below. FIG. 12 illustrates the GaN ingot 21 in perspective. As illustrated in FIG. 12, the GaN ingot 21 is a single crystal of GaN having a hexagonal crystal structure. The GaN ingot 21 is not limited to any particular electric conductivity type. The GaN ingot 21 has an upper surface, i.e., a first surface, 21a and a lower surface, i.e., a second surface, 21b that are positioned opposite each other along a thicknesswise direction 21c of the GaN ingot 21. According to the second embodiment, the GaN ingot 21 has no off-angle.

The upper surface 21a corresponds to (0001), and the lower surface 21b corresponds to (000-1). The thicknesswise direction 21c extends parallel to [0001]. The GaN ingot 21 has flat surfaces (e.g., facets) 23a and 23b on its side portion that will provide orientation flats of a GaN wafer 27 (see FIG. 16B) to be fabricated from the GaN ingot 21. The flat surface 23a is represented by {−1100}, and the flat surface 23b is represented by {11-20}.

The outer peripheral side surface 23e includes a first side surface 23c extending between the flat surfaces 23a and 23b and including a shorter arc interconnecting the flat surfaces 23a and 23b and a second side surface 23d extending between the flat surfaces 23a and 23b and including a longer arc interconnecting the flat surfaces 23a and 23b. The flat surfaces 23a and 23b and the first and second side surfaces 23c and 23d are joined perpendicularly to, i.e., traverse, the upper surface 21a and the lower surface 21b of the GaN ingot 21.

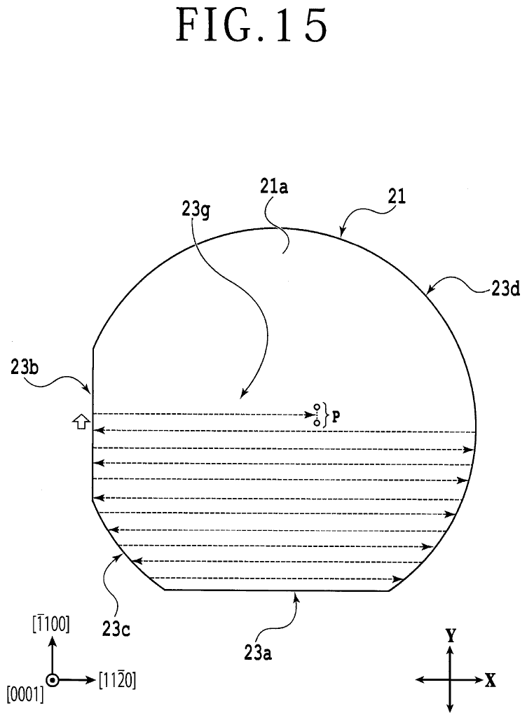

According to the present embodiment, laser beam applying step S30 is carried out after holding step S10 and mask preparing step S20. Laser beam applying step S30 includes outer peripheral area peel-off layer forming step S32 in which peel-off layers 15 are formed in an outer peripheral area 23f as illustrated in FIG. 13 and central area peel-off layer forming step S34 in which peel-off layers 15 are formed in a central area 23g as illustrated in FIG. 15. In laser beam applying step S30, outer peripheral area peel-off layer forming step S32 is carried out prior to central area peel-off layer forming step S34.

FIG. 13 illustrates, in plan, the GaN ingot 21 in outer peripheral area peel-off layer forming step S32 of the GaN wafer manufacturing method. Basically, outer peripheral area peel-off layer forming step S32 is carried out using the processing conditions described above in the first embodiment. In outer peripheral area peel-off layer forming step S32, however, focused spots P formed in the GaN ingot 21 and the GaN ingot 21 are not moved linearly relatively to each other, but are moved angularly relatively to each other by rotating the chuck table 4 that supports the GaN ingot 21 thereon at a predetermined rotational speed with the rotary drive mechanism 6. The predetermined rotational speed is set to such a value that at least one of the focused spots P moves at a speed that is substantially the same as the processing feed speed referred to in the above processing conditions, for example.

In this manner, the focused spots P and the GaN ingot 21 are moved angularly relatively to each other to cause the focused spots P to move along the outer peripheral area 23f of the GaN ingot 21. Each of annular broken lines A₁, A₂, and A₃ illustrated in FIG. 13 represents the track followed by a radially innermost focused spot P in the GaN ingot 21 among the tracks followed by respective focused spots P formed in the GaN ingot 21 by the laser beam L when the chuck table 4 is rotating.

At the start of outer peripheral area peel-off layer forming step S32, the height or vertical position of the focused spots P of the laser beam L is adjusted to keep the focused spots P at a predetermined depth 25 (see FIG. 16A) in the GaN ingot 21 from the upper surface 21a thereof. At this time, the focused spots P are arrayed along the Y-axis perpendicular to or traversing the outer peripheral side surface 23e.

In outer peripheral area peel-off layer forming step S32, the Y-axis extends perpendicularly to or in traversing relation to a circumferential direction along which the annular broken lines A₁, A₂, and A₃ extend, i.e., along which the focused spots P and the GaN ingot 21 are angularly moved relatively to each other. In outer peripheral area peel-off layer forming step S32, the second component L₂ of the laser beam L, i.e., the other part of the laser beam L, that is not masked by the masking unit 20 is applied to the GaN ingot 21 while the second component L₂ is being caused to branch into the focused spots P near the focused spots P arrayed along the Y-axis.

The chuck table 4 is then rotated in the direction indicated by the arrow 34 in FIG. 13 to make one revolution about its central axis. After the chuck table 4 has made one revolution, the focused spots P are moved radially inwardly of the GaN ingot 21. Specifically, the chuck table 4 is moved along the Y-axis, i.e., indexing-fed, by a predetermined indexing distance of 106 μm, for example. Thereafter, the chuck table 4 is rotated to make one revolution, i.e., a second revolution, about its central axis. Then, the chuck table 4 is indexing-fed and then rotated to make one revolution, i.e., a third revolution, about its central axis. In this manner, a plurality of annular peel-off layers 15, i.e., three annular peel-off layers 15 in FIG. 13, are successively formed concentrically in the outer peripheral area 23f of the GaN ingot 21.

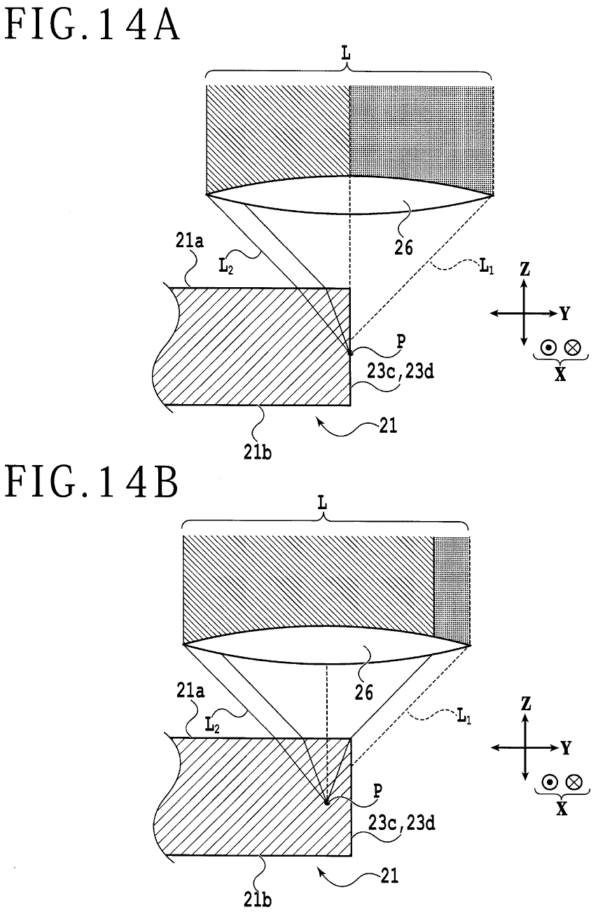

In outer peripheral area peel-off layer forming step S32, the laser beam L is applied to the GaN ingot 21 while the first component L₁ of the laser beam L, i.e., the part of the laser beam L, that enters the GaN ingot 21 via the outer peripheral side surface 23e, i.e., the first side surface 23c or the second side surface 23d, is being masked by the spatial light phase modulator 18 such that the first component L₁ has an intensity smaller than the processing threshold value of the GaN ingot 21. The extent to which the laser beam L is masked by the spatial light phase modulator 18 is adjusted by the controller 30 and the drive circuit 18a depending on the position where the laser beam L is applied to the GaN ingot 21. The manner in which the laser beam L is masked is illustrated in FIGS. 14A and 14B taken along line A-A in FIG. 13.

FIG. 14A schematically illustrates, in cross section, the manner in which the laser beam L has a substantial half that enters the GaN ingot 21 via the first side surface 23c or the second side surface 23d, but is masked by the spatial light phase modulator 18. For example, FIG. 14A illustrates the GaN ingot 21 that has made the first revolution about its central axis. In FIG. 14A, the laser beam L is not depicted as branching into a plurality of focused dots P, but is actually caused to branch into a plurality of focused dots P. FIG. 14B schematically illustrates, in cross section, the manner, in which the laser beam L has a smaller portion masked by the spatial light phase modulator 18 than the substantial half as illustrated in FIG. 14A. FIG. 14B also illustrates the GaN ingot 21 that has made the first revolution about its central axis. In FIG. 14B, the masked portion of the laser beam L is extremely small.

In FIGS. 14A and 14B, the part of the laser beam L that enters the GaN ingot 21 via the upper surface 21a thereof is depicted hatched, whereas the part of the laser beam L that is directed to enter the GaN ingot 21 via the outer peripheral side surface 23e thereof, but is actually masked by the masking unit 20 is depicted stippled. In FIG. 14B, the laser beam L is not depicted as branching into a plurality of focused dots P, in the same way as in FIG. 4B. However, the laser beam L is actually caused to branch into a plurality of focused dots P.

When the chuck table 4 is rotated about its central axis, the track followed by the laser beam L crosses the flat surfaces 23a and 23b as viewed in plan. When the track followed by the laser beam L crosses the flat surfaces 23a and 23b, the laser beam L enters the GaN ingot 21 via an extremely small area during an extremely short period of time. In outer peripheral area peel-off layer forming step S32 according to the second embodiment, therefore, the focused spots P and the GaN ingot 21 are not moved relatively to each other linearly along the flat surfaces 23a and 23b as viewed in plan.

In outer peripheral area peel-off layer forming step S32, the focused spots P and the GaN ingot 21 are moved relatively to each other only along the first side surface 23c and the second side surface 23d, i.e., portions of the outer peripheral area 23f. In FIG. 13, the three annular peel-off layers 15 are illustrated as being concentrically formed in the outer peripheral area 23f of the GaN ingot 21 by rotating the chuck table 4 to make three revolutions about its central axis. However, the number of revolutions that the chuck table 4 is rotated to make is not limited to three.

The number of revolutions that the chuck table 4 is rotated to make and hence the number of times that the chuck table 4 is indexing-fed may be determined as follows. The chuck table 4 is rotated about its central axis and the chuck table 4 or the focused spots P are indexing fed in alternate repetitive cycles until the track followed by a radially outermost focused spot P in the GaN ingot 21 is positioned radially inwardly of the flat surfaces 23a and 23b.

When the peel-off layers 15 are formed in the outer peripheral area 23f of the GaN ingot 21 in outer peripheral area peel-off layer forming step S32, Ga atoms and N atoms in the peel-off layers 15 are severed from each other, producing an N₂ gas, i.e., a nitrogen gas. If central area peel-off layer forming step S34 is carried out prior to outer peripheral area peel-off layer forming step S32, then a nitrogen gas produced by peel-off layers 15 formed in the central area 23g may possibly create an abnormal volumetrically expanded area in a radially inner area of the GaN ingot 21. The same problem tends to occur when the peel-off layers 15 that do not reach the outer peripheral side surface 11d are formed in the outer peripheral area 11c (see FIG. 8B).

According to the second embodiment, outer peripheral area peel-off layer forming step S32 is carried out prior to central area peel-off layer forming step S34, as described above. The peel-off layers 15 formed in the outer peripheral area 23f in peripheral area peel-off layer forming step S32 function as a passageway through which a nitrogen gas produced in the central area 23g in central area peel-off layer forming step S34 is released out of the GaN ingot 21. Therefore, an abnormal volumetric expansion can be prevented from taking place in a radially inner area of the GaN ingot 21 by performing outer peripheral area peel-off layer forming step S32 prior to central area peel-off layer forming step S34.

After outer peripheral area peel-off layer forming step S32, the focused spots P and the GaN ingot 21 are moved relatively to each other in the central area 23g of the GaN ingot 21 to form peel-off layers 15 in the central area 23g at substantially the same depth as the peel-off layers 15 formed in the outer peripheral area 23f. The central area 23g is positioned radially inwardly of the outer peripheral area 23f within the plane of the upper surface 21a or the lower surface 21b. In other words, the central area 23g is positioned radially inwardly of the outer peripheral area 23f with respect to the GaN ingot 21.

FIG. 15 illustrates, in plan, the GaN ingot 21 in central area peel-off layer forming step S34 of the GaN wafer manufacturing method. As illustrated in FIG. 15, in central area peel-off layer forming step S34, the orientation of the chuck table 4 is adjusted to make the direction [11-20] of the GaN ingot 21 substantially parallel to the X-axis. The focused spots P and the chuck table 4 are moved relatively to each other along the X-axis, i.e., processing-fed, and the focused spots P and the chuck table 4 are moved relatively to each other along the Y-axis, i.e., indexing-fed, in alternate repetitive cycles to form a plurality of straight peel-off layers 15 substantially parallel to each other in the GaN ingot 21 essentially in its entirety at the predetermined depth 25.

The focused spots P and the chuck table 4 may be processing-fed as follows. The focused spots P may be moved to the right in FIG. 15 in odd-numbered strokes of relative movement of the focused spots P and the chuck table 4, and the focused spots P may be moved to the left in FIG. 15 in even-numbered strokes of relative movement of the focused spots P and the chuck table 4.

Alternatively, the focused spots P may be moved to the right in FIG. 15 in even-numbered strokes of relative movement of the focused spots P and the chuck table 4, and the focused spots P may be moved to the left in FIG. 15 in odd-numbered strokes of relative movement of the focused spots P and the chuck table 4. The focused spots P and the chuck table 4 may be indexing-fed a predetermined indexing distance of 106 μm, for example, along the Y-axis. The other processing conditions for processing the GaN ingot 21 with the laser beam L may be those of the processing conditions described above in the first embodiment.

When central area peel-off layer forming step S34 is carried out, since the peel-off layers 15 have already been formed in the outer peripheral area 23f, the laser beam L that may enter the GaN ingot 21 via the flat surfaces 23a and 23b and the first and second side surfaces 23c and 23d do not contribute to irregular formation of peel-off layers 15.

After central area peel-off layer forming step S34, a GaN wafer 27 is peeled off from the GaN ingot 21 along the peel-off layers 15 in the outer peripheral area 23f and the peel-off layers 15 in the central area 23g that act as separation initiating points, with use of the peeling apparatus 40 (peeling step S40).

FIG. 16A illustrates the peeling apparatus 40 in elevation. As illustrated in FIG. 16A, the peeling apparatus 40 has a chuck table 42 that is substantially equal in diameter to the chuck table 4 described above. The chuck table 42 is of essentially the same structure as the chuck table 4 and has an upper surface functioning as a holding surface 42a for holding the GaN ingot 21 under suction thereon. The peeling apparatus 40 also has a peeling unit 44 disposed above the chuck table 42. The peeling unit 44 has a cylindrical movable member 46 whose longitudinal axis extends vertically along the Z-axis. The cylindrical movable member 46 has an upper end coupled to a Z-axis moving mechanism, not depicted.

The Z-axis moving mechanism is a ball-screw-type moving mechanism, for example, though it may be another actuator. The Z-axis moving mechanism moves the movable member 46 vertically along the Z-axis. A disk-shaped suction head 48 is mounted on the lower end of the movable member 46. The suction head 48 has a frame and a porous plate, not depicted, as with the chuck table 4 and hence the chuck table 42. The frame and the porous plate have respective lower surfaces lying substantially flatwise and parallel to the XY plane and functioning as a holding surface 48a.

In peeling step S40, the lower surface 21b of the GaN ingot 21 with a plurality of peel-off layers 15 formed therein is held under suction on the holding surface 42a of the chuck table 42, and at the same time the upper surface 21a of the GaN ingot 21 is held under suction on the holding surface 48a of the suction head 48. Then, an external force is exerted on the GaN ingot 21. Specifically, a wedge, not depicted, is driven into the side surface of the GaN ingot 21 at the height or vertical position aligned with the peel-off layers 15 in the GaN ingot 21, thereby applying an external force to the GaN ingot 21. Preferably, the wedge or a plurality of wedges should be driven into the side surface of the GaN ingot 21 at respective locations that are spaced circumferentially around the GaN ingot 21 rather than at a single location.

The external force thus applied causes the cracks in the peel-off layers 15 to develop further in the GaN ingot 21. Rather than driving the wedge(s) into the side surface of the GaN ingot 21, ultrasonic waves, i.e., elastic vibratory waves in a frequency range in excess of 20 kHz, may be applied to the GaN ingot 21 thereby to apply an external force to the GaN ingot 21. Specifically, the ultrasonic waves are applied to the upper surface 21a of the GaN ingot 21 through liquid such as pure water, for example, before the upper surface 21a is held under suction on the holding surface 48a of the suction head 48. More specifically, liquid to which ultrasonic waves are applied is ejected from a nozzle, not depicted, to the GaN ingot 21. Alternatively, ultrasonic waves are applied from an ultrasonic horn to the upper surface 21a of the GaN ingot 21 through liquid. In a case where a nozzle or an ultrasonic horn is used, an external force is applied by way of ultrasonic waves to a local region, that is 5 mm to 50 mm across, of the upper surface 21a. Then, the nozzle or the ultrasonic horn and the chuck table 42 are moved relatively to each other to apply an external force to other regions of the upper surface 21a.

By gradually spreading the regions of the upper surface 21a to which the external forces have been applied by the wedge(s) or the ultrasonic waves, the cracks between the modified layers 13 of the peel-off layers 15 are developed in the GaN ingot 21 along the upper surface 21a. The application of external forces further develops the cracks between adjacent ones of the modified layers 13, weakening the mechanical strength of the peel-off layers 15. After the external forces have thus been applied to the GaN ingot 21, the suction head 48 that is holding the GaN ingot 21 under suction is lifted away from the chuck table 42. Concurrent with lifting the suction head 48, external forces may be applied to the GaN ingot 21. As the suction head 48 is lifted, a GaN wafer 27 is peeled off from the GaN ingot 21 along the peel-off layers 15 acting as separation initiating points.

FIG. 16B illustrates, in elevation, the GaN ingot 21 and the GaN wafer 27 available after peeling step S40. After peeling step S40, surface irregularities remaining on the surface of the GaN ingot 21 from which the GaN wafer 27 has been peeled off and surface irregularities remaining on the surface of the GaN wafer 27 that has been peeled off from the GaN ingot 21 may be removed by grinding or polishing. In this manner, the GaN wafer 27 that has a thickness smaller than the thickness of the GaN ingot 21, i.e., the distance between the upper surface 21a and the lower surface 21b, is fabricated from the GaN ingot 21.

A GaN wafer 27 may be fabricated from a monocrystalline GaN substrate, i.e., a workpiece, that is shaped as a rectangular plate or a disk-shaped plate, rather than the GaN ingot 21, the GaN wafer 27 having a thickness smaller than the thickness of the monocrystalline GaN substrate. The monocrystalline GaN substrate may be a bare substrate or a crystalline substrate having a monocrystalline substrate as a seed crystal and an epitaxial growth layer grown on the monocrystalline substrate.

In outer peripheral area peel-off layer forming step S32 according to the second embodiment, the masking unit 20 includes the spatial light phase modulator 18. However, the masking unit 20 having the mask 32 according to the modification of the first embodiment (see FIGS. 10A and 10B) may be used to mask part of the laser beam L. If the mask 32 is used, then the extent to which the laser beam L is masked by the mask 32 needs to be adjusted depending on the position where the laser beam L is applied to the GaN ingot 21. However, since the mask 32 is unable to adjust the extent to which the laser beam L is masked with an electric signal unlike the spatial light phase modulator 18, a plurality of masks 32 having differently sized openings 32c are prepared and made available to choose from for adjusting the extent to which the laser beam L is masked.

The GaN ingot 21 according to the second embodiment has no off-angle. Irrespective of whether there is an off-angle or not, it is preferable to orient the X-axis within <11-20>±5° of the GaN ingot 21 when the GaN ingot 21 is processed.

### (Modification)

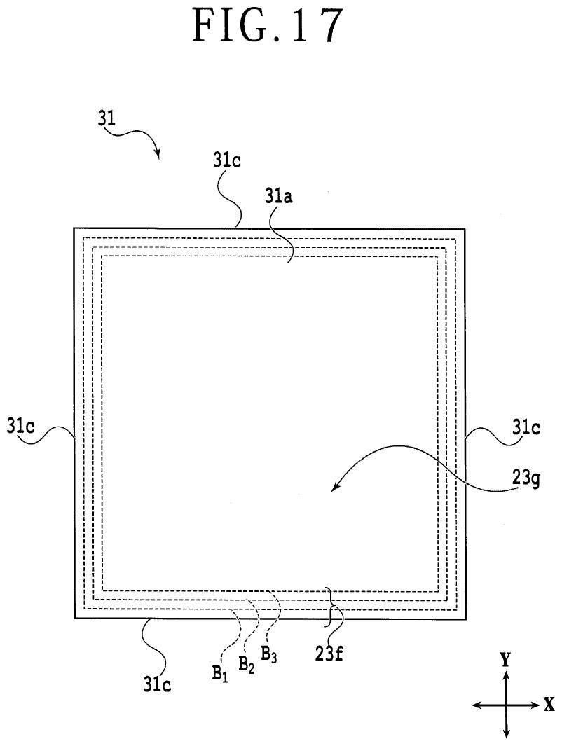

A modification of the second embodiment will be described below with reference to FIG. 17. According to the present modification, a GaN wafer, not depicted, shaped as a rectangular plate is fabricated from a monocrystalline GaN substrate 31 (see FIG. 17) that is shaped as a rectangular plate, the GaN wafer having a thickness smaller than the thickness of the monocrystalline GaN substrate 31. According to the present modification, the steps of the flowchart illustrated in FIG. 17 are carried out to fabricate the GaN wafer. In outer peripheral area peel-off layer forming step S32, however, the tracks of the focused spots P are of a rectangular shape along the sides of the monocrystalline GaN substrate 31, rather than a circular shape. The monocrystalline GaN substrate 31 includes an outer peripheral area 23f and a central area 23g that are similar to those illustrated in FIG. 13. Therefore, reference should be made to FIG. 13 as regards the details of the outer peripheral area 23f and the central area 23g.

FIG. 17 illustrates, in plan, the monocrystalline GaN substrate 31 shaped as a rectangular plate in outer peripheral area peel-off layer forming step S32. Each of broken lines B₁, B₂, and B₃ illustrated in FIG. 17 represents the track followed by a focused spot P closest to the center of an upper surface, i.e., a first surface, 31 of the monocrystalline GaN substrate 31 at the time the chuck table 4 on which the monocrystalline GaN substrate 31 is held under suction is processing-fed in outer peripheral area peel-off layer forming step S32.

At the start of a process of processing the monocrystalline GaN substrate 31 along an outermost peripheral area thereof, a plurality of focused spots P of the laser beam L are arrayed along the Y-axis while the height or vertical position of the focused spots P is being adjusted to keep the focused spots P at a predetermined depth in the monocrystalline GaN substrate 31. At this time, part of the laser beam L is masked to prevent the laser beam L from entering the monocrystalline GaN substrate 31 via an outer peripheral side surface positioned on an outer peripheral edge 31c thereof.

Then, the chuck table 4 is processing-fed in a predetermined direction, e.g., a +X direction, along the X-axis at a predetermined processing feed speed to move the focused spots P and the monocrystalline GaN substrate 31 relatively to each other along one side of the outer peripheral edge 31c from one end to the other end thereof, thereby forming a peel-off layer 15 in the monocrystalline GaN substrate 31 in the outer peripheral area 23f along the one side of the outer peripheral edge 31c. Then, the chuck table 4 is turned 90° in a predetermined direction around the center thereof. Thereafter, the chuck table 4 is processing-fed in a direction, e.g., a −X direction, opposite the above predetermined direction at a predetermined processing feed speed to move the focused spots P and the monocrystalline GaN substrate 31 relatively to each other along another side of the outer peripheral edge 31c from one end to the other end thereof, thereby forming a peel-off layer 15 in the monocrystalline GaN substrate 31 in the outer peripheral area 23f along the other side of the outer peripheral edge 31c.

Similarly, peel-off layers 15 are formed in the monocrystalline GaN substrate 31 in the outer peripheral area 23f along the remaining sides of the outer peripheral edge 31c. After the peel-off layers 15 have been formed along a first rectangular path in the outer peripheral area 23f along the outer peripheral edge 31c, the focused spots P are moved inwardly away from the outer peripheral edge 31c. Specifically, the chuck table 4 is indexing-fed along the Y-axis by a predetermined indexing distance of 106 μm, for example. Then, the monocrystalline GaN substrate 31 is processed with the laser beam L to form peel-off layers 15 along a second rectangular path in the outer peripheral area 23f along the outer peripheral edge 31c. After the monocrystalline GaN substrate 31 has been processed with the laser beam L to form peel-off layers 15 along a third rectangular path in the outer peripheral area 23f along the outer peripheral edge 31c, outer peripheral area peel-off layer forming step S32 is finished. Then, central area peel-off layer forming step S34 and peeling step S40 are carried out in the same manner as with the second embodiment.

According to the first and second embodiments and the modifications thereof, the laser beam L is caused to branch into a plurality of focused spots P. Although it is expected to take a prolonged period of time for processing the workpiece, the laser beam L may not necessarily be caused to branch into a plurality of focused spots P as long as part of the laser beam L that enters the workpiece via the outer peripheral side surface is masked. The structural and methodological details of the embodiments and the modifications described above may be changed or modified without departing from the scope of the invention.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser processing method comprising:
a mask preparing step of adjusting a masking unit for masking part of a pulsed laser beam having a wavelength transmittable through a column-shaped or plate-shaped workpiece that has a first surface, a second surface opposite the first surface, and an outer peripheral side surface traversing the first surface and the second surface, when the laser beam is applied to an outer peripheral area of the workpiece in a direction from the first surface to the second surface, such that part of the laser beam that enters the workpiece via the outer peripheral side surface has an intensity smaller than a processing threshold value of the workpiece; and
after the mask preparing step, a laser beam applying step of, having adjusted a height of a focused spot of the laser beam to position the focused spot within the workpiece, moving the focused spot and the workpiece relatively to each other so as to move the focused spot along the outer peripheral area, thereby forming a modified layer in the workpiece while masking, with the masking unit, the part of the laser beam that enters the workpiece via the outer peripheral side surface such that the part of the laser beam has the intensity smaller than the processing threshold value of the workpiece.

2. The laser processing method according to claim 1, wherein
the masking unit has a spatial light phase modulator for at least partly modulating the laser beam or a metal mask for partly masking the laser beam, and
the laser beam applying step includes masking the part of the laser beam by at least partly modulating the laser beam with the spatial light phase modulator to weaken the intensity of the laser beam or physically masking the part of the laser beam with the metal mask.

3. The laser processing method according to claim 1, wherein
the laser beam applying step includes causing another part of the laser beam that has not been masked by the masking unit to branch into a plurality of focused spots arrayed in a predetermined direction that traverses, in a plan view of the workpiece, a direction along which the focused spot and the workpiece are moved relatively to each other, and applying the other part of the laser beam to the workpiece.

4. A gallium nitride wafer manufacturing method of manufacturing a gallium nitride wafer from a workpiece that is either a gallium nitride ingot or a monocrystalline gallium nitride substrate, the gallium nitride wafer having a thickness smaller than the thickness of the workpiece, the workpiece having a first surface, a second surface opposite the first surface, and an outer peripheral side surface traversing the first surface and the second surface, the method comprising:
an outer peripheral area peel-off layer forming step of, having adjusted a height of a focused spot of a pulsed laser beam having a wavelength transmittable through the workpiece so as to position the focused spot within the workpiece, moving the workpiece and the focused spot relatively to each other so as to move the focused spot along an outer peripheral area of the workpiece, thereby forming a peel-off layer in the outer peripheral area;
after the outer peripheral area peel-off layer forming step, a central area peel-off layer forming step of moving the focused spot and the workpiece relatively to each other in a central area of the workpiece that is positioned inwardly of the outer peripheral area in a plane of the first surface or the second surface, thereby forming a peel-off layer in the central area; and
a peeling step of peeling off a gallium nitride wafer from the workpiece along the peel-off layer in the outer peripheral area and the peel-off layer in the central area, the peel-off layers acting as separation initiating points, wherein
the outer peripheral area peel-off layer forming step includes forming the peel-off layer in the workpiece while masking, with a masking unit, part of the laser beam that enters the workpiece via the outer peripheral side surface such that the part of the laser beam has an intensity smaller than a processing threshold value of the workpiece.

5. The gallium nitride wafer manufacturing method according to claim 4, wherein
the masking unit has a spatial light phase modulator for at least partly modulating the laser beam or a metal mask for partly masking the laser beam, and
the outer peripheral area peel-off layer forming step includes masking the part of the laser beam by at least partly modulating the laser beam with the spatial light phase modulator to weaken the intensity of the laser beam or physically masking the part of the laser beam with the metal mask.

6. The Gallium nitride wafer manufacturing method according to claim 4, wherein
the outer peripheral area peel-off layer forming step includes causing another part of the laser beam that has not been masked by the masking unit to branch into a plurality of focused spots arrayed in a predetermined direction that traverses, in a plan view of the workpiece, a direction along which the focused spot and the workpiece are moved relatively to each other, and applying the other part of the laser beam to the workpiece.
